(19) United States
(12) Patent Application Publication
(10) Pub. No.: US 2022/0391121 A1
(43) Pub. Date: Dec. 8, 2022

(54) Virtual Disk Migration Method, Apparatus and Device, and Readable Storage Medium

(71) Applicant: Inspur Electronic Information Industry Co., Ltd., Jinan, Shangdong (CN)

(72) Inventors: Zhen Feng, Jinan , Shangdong (CN); Bingheng Yan, Jinan, Shangdong (CN); Lixiang Wang, Jinan, Shangdong (CN); Feng Yang, Jinan, Shangdong (CN)

(21) Appl. No.: 17/640,300

(22) PCT Filed: Nov. 28, 2019
(86) PCT No.: PCT/CN2019/121572

§ 371 Date: Aug. 15, 2022

(30) Foreign Application Priority Data
Sep. 5, 2019 (CN) 201910838357.X

(51) Int. Cl. G06F 3/06; G06F 9/455

(52) U.S. Cl. CPC G06F 3/0647; G06F 9/45558; G06F 3/0619; G06F 3/0664; G06F 3/067; G06F 2009/4557; G06F 2009/45583

(57) ABSTRACT

A virtual disk migration method, apparatus and device, and a readable storage medium. Said method comprises: when a data change occurs in a cluster, updating the label of the cluster in a binary table to a first target value (S101); copying data in the cluster to a second data center, and updating the first target value to a second target value (S102); and upon reception of an instruction for migrating a virtual machine to the second data center (S103), controlling the virtual machine to stop operating, querying the first target value in the binary table, and migrating data in the cluster corresponding to the queried first target value to the second data center (S104). A part of data is copied to a second data center in advance on the basis of a binary table, and when a virtual machine is migrated, only the other part of data needs to be migrated, thereby reducing the data migration amount and migration time, and improving the migration efficiency of a virtual disk and a virtual machine.

This application claims priority to Chinese patent application No. 201910838357.X, entitled “VIRTUAL DISK MIGRATION METHOD, APPARATUS AND DEVICE, AND READABLE STORAGE MEDIUM”, filed with the China National Intellectual Property Administration on Sep. 5, 2019, the disclosure of which is hereby incorporated by reference in its entirety.

### TECHNICAL FIELD

The present application relates to the field of computer technologies, and in particular, to a virtual disk migration method, apparatus and device, and a readable storage medium.

### BACKGROUND ART

In the prior art, a backup disk is generally disposed at a source end. The backup disk is used to back up data in a virtual disk corresponding to a virtual machine operating at the source end. When it is necessary to migrate the virtual machine at the source end to a destination end, all the data in the backup disk is directly migrated to the destination end, so as to complete the migration of the virtual disk corresponding to the virtual machine and implement the migration of the virtual machine accordingly As can be seen, in such an existing migration method, all the data in the backup disk needs to be migrated to the destination end at once. In this case, the data migration amount is relatively large, resulting in an increased migration time and reduced migration efficiency of a virtual disk and a virtual machine.

Therefore, how to improve the migration efficiency of virtual disks is a problem to be resolved by a person skilled in the art.

### SUMMARY OF THE INVENTION

In view of this, an objective of the of the present application is to provide a virtual disk migration method, apparatus and device, and a readable storage medium, thereby improving the migration efficiency of virtual disks. Specific solutions of the present application are as follows:

According to a first aspect, the present application provides a virtual disk migration method, applied to a first data center, a source virtual disk corresponding to a virtual machine operating in the first data center being divided into a plurality of clusters, the method including:

when a data change occurs in a cluster, updating the label of the cluster in a binary table to a first target value; copying data in the cluster to a second data center, and updating the first target value to a second target value; and

if an instruction for migrating the virtual machine to the second data center is received, controlling the virtual machine to stop operating, querying the first target value in the binary table, and migrating data in the cluster corresponding to the queried first target value to the second data center.

Preferably, the second data center is a disaster recovery center of the first data center; and if a corresponding backup virtual disk is disposed for a disaster recovery virtual disk in the second data center, the copying data in the cluster to a second data center includes: copying the data in the cluster to the backup virtual disk, where the disaster recovery virtual disk is disposed in the second data center and is configured to perform disaster recovery on data in the source virtual disk; and correspondingly, the migrating data in the cluster corresponding to the queried first target value to the second data center includes: migrating data in the cluster corresponding to the queried first target value to the backup virtual disk.

Preferably, after the migrating data in the cluster corresponding to the queried first target value to the backup virtual disk, the method further includes:

controlling, by the second data center, the virtual machine to operate on the basis of the backup virtual disk.

Preferably, before the controlling the virtual machine to operate on the basis of the backup virtual disk, the method further includes:

migrating a memory resource of the virtual machine to the backup virtual disk.

Preferably, the migrating data in the cluster corresponding to the queried first target value to the second data center includes:

migrating data in the cluster corresponding to the queried first target value to the disaster recovery virtual disk.

Preferably, an initialization step of the binary table includes:

calculating a difference value between the backup virtual disk and the source virtual disk; and

determining the difference value as an initial label of each cluster of the source virtual disk in the binary table.

Preferably, the copying data in the cluster to a second data center includes:

if a data copy time point is reached, performing the step of copying data in the cluster to a second data center.

According to a second aspect, the present application provides a virtual disk migration apparatus, applied to a first data center, a source virtual disk corresponding to a virtual machine operating in the first data center being divided into a plurality of clusters, the method including:

a copy module, configured to: when a data change occurs in a cluster, update the label of the cluster in a binary table to a first target value; copy data in the cluster to a second data center, and update the first target value to a second target value; and

a migration module, configured to: if an instruction for migrating the virtual machine to the second data center is received, control the virtual machine to stop operating, query the first target value in the binary table, and migrate data in the cluster corresponding to the queried first target value to the second data center.

According to a third aspect, this application provides a virtual disk migration device, including:

a memory, configured to store a computer program; and

a processor, configured to execute the computer program to implement the virtual disk migration method disclosed above.

According to a fourth aspect, this application provides a readable storage medium, storing a computer program, the computer program being executed by a processor to implement the virtual disk migration method disclosed above.

As can be seen from the foregoing solutions, the present application provides a virtual disk migration method, applied to a first data center, a source virtual disk corresponding to a virtual machine operating in the first data center being divided into a plurality of clusters, the method including: when a data change occurs in a cluster, updating the label of the cluster in a binary table to a first target value; copying data in the cluster to a second data center, and updating the first target value to a second target value; and if an instruction for migrating the virtual machine to the second data center is received, controlling the virtual machine to stop operating, querying the first target value in the binary table, and migrating data in the cluster corresponding to the queried first target value to the second data center.

As can be seen, in the method, before the virtual machine is migrated to the second data center, data in the virtual disk is labeled by using the binary table to distinguish between updated data and unupdated data. The first target value is used for labeling that data is updated. The second target value is used for labeling that data is not updated or is updated but has been copied. In the present application, a part of data in a virtual disk corresponding to a virtual machine is copied in advance to a second data center on the basis of a binary table. In this case, when a virtual machine is migrated, only uncopied data in the virtual disk needs to be migrated, thereby reducing the data migration amount and migration time, and improving the migration efficiency of a virtual disk and a virtual machine. The part of data copied to the second data center in advance is updated data in the virtual disk. The data migrated during the migration of the virtual machine is data that remains unupdated in the virtual disk and/or data that is updated but has not been copied to the second data center.

Correspondingly, the virtual disk migration apparatus and device and the readable storage medium provided in the present application also have the foregoing technical effects.

### BRIEF DESCRIPTION OF THE DRAWINGS

To describe the technical solutions in the embodiments of this application or the prior art more clearly, the following briefly introduces the accompanying drawings required for describing the embodiments or the prior art. Apparently, the accompanying drawings in the following description show merely embodiments of this application, and a person of ordinary skill in the art may still derive other drawings from the provided accompanying drawings without creative efforts.

FIG. 1 is a flowchart of a first virtual disk migration method according to the present application;

FIG. 2 is a flowchart of a second virtual disk migration method according to the present application;

FIG. 3 is a schematic diagram of a virtual disk migration system according to the present application;

FIG. 4 is a schematic diagram of a virtual disk migration apparatus according to the present application; and

FIG. 5 is a schematic diagram of a virtual disk migration device according to the present application.

### DETAILED DESCRIPTION OF THE EMBODIMENTS

The following clearly and completely describes the technical solutions in embodiments of this application with reference to the accompanying drawings in embodiments of this application. Apparently, the described embodiments are some rather than all of the embodiments of the present application. All other embodiments obtained by persons of ordinary skill in the art on the basis of the embodiments of the present application without creative efforts shall fall within the protection scope of the present application.

At present, in an existing migration method, all data in a backup disk needs to be migrated to a destination end at once. In this case, the data migration amount is relatively large, resulting in an increased migration time and reduced migration efficiency of a virtual disk and a virtual machine. For this, the present application provides a virtual disk migration solution, so that the migration efficiency of virtual disks can be improved.

As shown in FIG. 1, embodiments of the present application provide a first virtual disk migration method. The method is applied to a first data center. A source virtual disk corresponding to a virtual machine operating in the first data center is divided into a plurality of clusters. The method includes the following steps.

S101: When a data change occurs in a cluster, update the label of the cluster in a binary table to a first target value.

Specifically, when data in a cluster in a virtual disk is changed, the label of the cluster in a binary table is updated to a first target value. The first target value is used for labeling updated data.

S102: Copy data in the cluster to a second data center, and update the first target value to a second target value.

Further, data in a cluster with the label of the first target value is copied to the second data center, that is, updated data is copied to the second data center, and at the same time the first target value is updated to the second target value, the second target value is used for labeling unupdated data and/or updated but copied data.

S103: Receive an instruction for migrating the virtual machine to the second data center.

S104: Control the virtual machine to stop operating, query the first target value in the binary table, and migrate data in the cluster corresponding to the queried first target value to the second data center.

When the instruction for migrating the virtual machine to the second data center is received, the binary table is searched for the first target value. In this case, the data in the cluster corresponding to the found first target value includes: unupdated data, updated but copied data, and data that is updated but has not been copied, that is, the other part of data that needs to be migrated. Therefore, this part of data is migrated to the second data center, and migration of all data in the virtual disk is completed.

In a specific implementation, an initialization step of the binary table includes: calculating a difference value between the backup virtual disk and the source virtual disk; and determining the difference value as an initial label of each cluster of the source virtual disk in the binary table.

Specifically, the backup virtual disk is also divided into a plurality of clusters. The clusters in the backup virtual disk correspond one to one to the clusters in the source virtual disk. Therefore, the difference between the backup virtual disk and the source virtual disk is corresponding differences between the clusters in the backup virtual disk and the clusters in the source virtual disk. When data stored in a cluster in the backup virtual disk is consistent with data stored in a corresponding cluster in the source virtual disk, the difference between the two clusters may be denoted as “0”, or otherwise denoted as “1”. “0” is the second target value, and “1” is the first target value. Therefore, the label of a cluster in the source virtual disk in the binary table is consistent with the label of a corresponding cluster in the backup virtual disk in the binary table.

It needs to be noted that a data copy period may be set. When a data copy time point is reached, data in a cluster with the label of the first target value is copied to the second data center. Data is copied in batches within a preset time period.

As can be seen, in this embodiment, before the virtual machine is migrated to the second data center, data in the virtual disk is labeled by using the binary table to distinguish between updated data and unupdated data. The first target value is used for labeling that data is updated. The second target value is used for labeling that data is not updated or is updated but has been copied. In the present application, a part of data in a virtual disk corresponding to a virtual machine is copied in advance to a second data center on the basis of a binary table. In this case, when a virtual machine is migrated, only uncopied data in the virtual disk needs to be migrated, thereby reducing the data migration amount and migration time, and improving the migration efficiency of a virtual disk and a virtual machine.

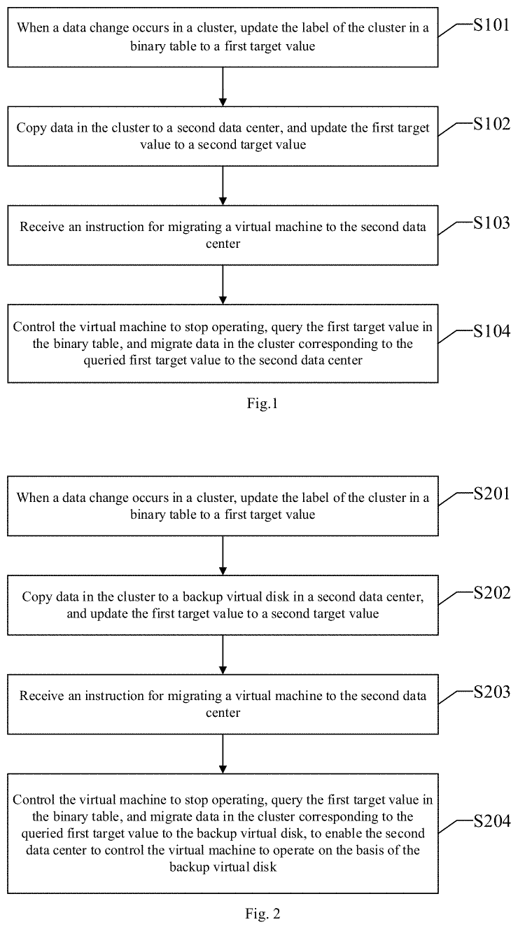

As shown in FIG. 2, embodiments of the present application provide a second virtual disk migration method. The method is applied to a first data center. A source virtual disk corresponding to a virtual machine operating in the first data center is divided into a plurality of clusters. A second data center is a disaster recovery center of the first data center. A disaster recovery virtual disk is disposed in the second data center, and is configured to perform disaster recovery on data in the source virtual disk. The method includes the following steps.

S201: When a data change occurs in a cluster, update the label of the cluster in a binary table to a first target value.

S202: Copy data in the cluster to a backup virtual disk in a second data center, and update the first target value to a second target value.

S203: Receive an instruction for migrating the virtual machine to the second data center.

S204: Control the virtual machine to stop operating, query the first target value in the binary table, and migrate data in the cluster corresponding to the queried first target value to the backup virtual disk, to enable the second data center to control the virtual machine to operate on the basis of the backup virtual disk.

In a specific implementation, before the controlling the virtual machine to operate on the basis of the backup virtual disk, the method further includes: migrating a memory resource of the virtual machine to the backup virtual disk. The backup virtual disk is a backup disk of the disaster recovery virtual disk.

The migrating data in the cluster corresponding to the queried first target value to the second data center includes: migrating data in the cluster corresponding to the queried first target value to the disaster recovery virtual disk. That is, when a virtual machine is migrated, remaining data that needs to be migrated is migrated to the disaster recovery virtual disk, and then data in the disaster recovery virtual disk is migrated to the backup virtual disk. In this way, the backup virtual disk stores all data in the source virtual disk. In this case, the backup virtual disk and the disaster recovery virtual disk store the same data. Therefore, during migration of data in the disaster recovery virtual disk to the backup virtual disk, only data that does not exist in the backup virtual disk needs to be migrated to the backup virtual disk. The data that does not exist in the backup virtual disk is remaining data that needs to be migrated during the migration of the virtual machine.

It needs to be noted that the implementation steps in this embodiment are the same as or similar to those in the foregoing embodiments, reference may be made to each other if necessary, and details are not described again in this embodiment.

As can be seen from above, in this embodiment, before the virtual machine is migrated to the second data center, data in the virtual disk is labeled by using the binary table to distinguish between updated data and unupdated data. The first target value is used for labeling that data is updated. The second target value is used for labeling that data is not updated or is updated but has been copied. In the present application, a part of data in a virtual disk corresponding to a virtual machine is copied in advance to a second data center on the basis of a binary table. In this case, when a virtual machine is migrated, only uncopied data in the virtual disk needs to be migrated, thereby reducing the data migration amount and migration time, and improving the migration efficiency of a virtual disk and a virtual machine.

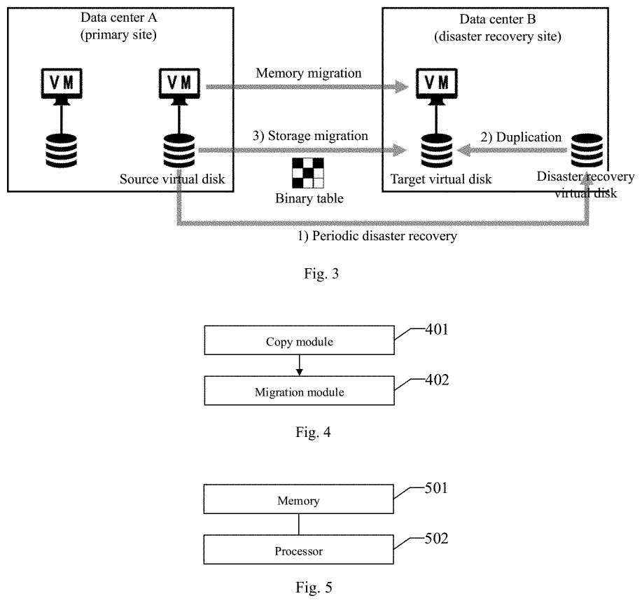

Referring to FIG. 3, embodiments of this application disclose a virtual disk migration system. The system includes a data center A (that is, a first data center) and a data center B (that is, a second data center). The data center A has a plurality of source virtual disks. Each source virtual disk is divided into a plurality of clusters.

The data center B is a disaster recovery center of the data center A. The data center B is provided with a disaster recovery virtual disk corresponding to the source virtual disk and is provided with a backup disk, that is, a target virtual disk of the disaster recovery virtual disk.

In FIG. 3, 1) periodic disaster recovery, 2) duplication, and 3) storage migration need to be performed. Refer to the following process for details.

Specifically, data in the source virtual disk may be duplicated to the disaster recovery virtual disk periodically at 24:00 every day to establish the backup disk, that is, the target virtual disk of the disaster recovery virtual disk. In this case, on the second day, the data center A maintains a binary table. If data in a cluster in a virtual disk in the data center A is changed, the cluster is labeled with 1 (that is, a first target value) in the binary table; or otherwise, the cluster is labeled with 0 (that is, a second target value) in the binary table. For a cluster labeled with 1, data in the cluster is copied to a backup virtual disk (that is, the target virtual disk in FIG. 3) of the data center B in time. After copying is completed, the cluster is labeled with 0.

If the data center A triggers a virtual machine migration procedure on the second day, the data center A controls a to-be-migrated virtual machine to stop operating, and searches the binary table for clusters labeled with 1, to further migrate data in the clusters labeled with 1 to the target virtual disk in the data center B. In this case, the target virtual disk stores all data in a source virtual disk corresponding to a current virtual machine. In this case, data in the disaster recovery virtual disk has been stored in the target virtual disk. Therefore, the data in the disaster recovery virtual disk may be cleared to wait till 24:00 on the second day to perform disaster recovery on data in another source virtual disk.

Further, the data center B migrates a memory resource of a virtual machine corresponding to a source virtual disk in time to complete migrate of the virtual machine.

It needs to be noted that the implementation steps in this embodiment are the same as or similar to those in the foregoing embodiments. Therefore, details are not described herein again in this embodiment. Reference may be made to each other if necessary, and details are not described again in this embodiment.

In this embodiment, during migration of a virtual disk, it is not necessary to perform full copy on the virtual disk, thereby reducing the migration time of a virtual machine and improving the migration efficiency of a virtual disk and a virtual machine.

A virtual disk migration apparatus provided in the embodiments of the present application is described below. For the virtual disk migration apparatus described below and the virtual disk migration method described above, reference may be made to each other.

As shown in FIG. 4, embodiments of the present application provide a virtual disk migration apparatus. The method is applied to a first data center. A source virtual disk corresponding to a virtual machine operating in the first data center is divided into a plurality of clusters. The apparatus includes:

a copy module 401, configured to: when a data change occurs in a cluster, update the label of the cluster in a binary table to a first target value; and copy data in the cluster to a second data center, and update the first target value to a second target value; and

a migration module 402, configured to: if an instruction for migrating the virtual machine to the second data center is received, control the virtual machine to stop operating, query the first target value in the binary table, and migrate data in the cluster corresponding to the queried first target value to the second data center.

In a specific implementation, the second data center is a disaster recovery center of the first data center; and if a corresponding backup virtual disk is disposed for a disaster recovery virtual disk in the second data center,

the copy module is specifically configured to:

copy data in the cluster to the backup virtual disk, a disaster recovery virtual disk is disposed in the second data center, and is configured to perform disaster recovery on data in the source virtual disk; and

correspondingly, the migration module is specifically configured to:

migrate data in the cluster corresponding to the queried first target value to the backup virtual disk.

In a specific implementation, the second data center is specifically configured to migrate a memory resource of the virtual machine to the backup virtual disk, and control the virtual machine to operate on the basis of the backup virtual disk.

In a specific implementation, the migration module is specifically configured to:

migrate data in the cluster corresponding to the queried first target value to the disaster recovery virtual disk.

In a specific implementation, the virtual disk migration apparatus further includes a binary table initialization module, and the binary table initialization module includes:

a calculation unit, configured to calculate a difference value between the backup virtual disk and the source virtual disk; and

a determination unit, configured to determine the difference value as an initial label of each cluster of the source virtual disk in the binary table.

In a specific implementation, the copy module is specifically configured to:

if a data copy time point is reached, perform the step of copying data in the cluster to a second data center.

For a more specific working process of the modules and units in this embodiment, reference may be made to the corresponding content disclosed in the foregoing embodiments. Details are not described herein again.

As can be seen, this embodiment provides a virtual disk migration apparatus. The apparatus can reduce the data migration amount and migration time, and improve the migration efficiency of a virtual disk and a virtual machine.

A virtual disk migration device provided in the embodiments of the present application is described below. For the virtual disk migration device described below and the virtual disk migration method and apparatus described above, reference may be made to each other.

Referring to FIG. 5, an embodiment of the present application discloses a virtual disk migration device, including:

a memory 501, configured to store a computer program; and

a processor 502, configured to execute the computer program to implement the method disclosed in any foregoing embodiment.

A readable storage medium provided in the embodiments of the present application is described below. For the readable storage medium described below and the virtual disk migration method, apparatus and device described above, reference may be made to each other.

A readable storage medium is configured to store a computer program, the computer program being executed by a processor to implement the virtual disk migration method disclosed in the foregoing embodiments. For specific steps of the method, reference may be made to the corresponding content disclosed in the foregoing embodiments. Details are not described herein again.

“First”, “second”, “third”, “fourth”, and the like (if exist) involved in the present application are only used to distinguish between similar objects, but are not used to describe a specific order or time sequence. It should be understood that the data thus used are interchangeable in appropriate circumstances and that the embodiments described herein can be implemented in other sequences than the content illustrated or described. In addition, the terms “include”, “include”, and any variation of such terms in the description and claims of the present application is intended to cover a non-exclusive inclusion. For example, a process, method or device that includes a series of steps or units not only includes those steps or units specified expressly, but also includes other steps or units that are not specified expressly or are inherent to the process, method or device.

It needs to be noted that in the present application, description of “first”, “second”, and the like are used only for description, but are not intended to indicate or imply relative importance or implicitly specify a quantity of indicated technical features. Therefore, the features limited by “first” and “second” may explicitly or implicitly include at least one such feature. In addition, the technical solutions between the various embodiments can be combined with each other on the basis of that a combination can be implemented by a person of ordinary skill in the art. When a combination of technical solutions encounters a contradiction or cannot be implemented, it should be considered that this combination of technical solutions does not exist and does not fall within the scope of protection that the present application seeks to protect.

All embodiments are described in the present invention by using the progressive method. Each embodiment describes only the difference from other embodiments. For the same or similar parts among all embodiments, reference may be made to the relevant parts.

Steps of methods or algorithms described in the embodiments disclosed in this specification may be directly implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of readable storage medium known in the art.

Although the principle and implementation manners of the present application are described by using specific examples in this specification, descriptions of the embodiments are merely intended to help understand the methods and core idea of the present application. In addition, for a person of ordinary skill in the art, according to the idea of the present application, changes may be made to the specific implementation and the scope of application. In summary, the content of this specification should not be construed as a limitation to the present application.

1. A virtual disk migration method, applied to a first data center, a source virtual disk corresponding to a virtual machine operating in the first data center being divided into a plurality of clusters, the method comprising:
when a data change occurs in a cluster, updating the label of the cluster in a binary table to a first target value; copying data in the cluster to a second data center, and updating the first target value to a second target value; and
if an instruction for migrating the virtual machine to the second data center is received, controlling the virtual machine to stop operating, querying the first target value in the binary table, and migrating data in the cluster corresponding to the queried first target value to the second data center.

2. The virtual disk migration method according to claim 1, wherein the second data center is a disaster recovery center of the first data center; and
if a corresponding backup virtual disk is disposed for a disaster recovery virtual disk in the second data center, the copying data in the cluster to a second data center comprises: copying the data in the cluster to the backup virtual disk, wherein the disaster recovery virtual disk is disposed in the second data center and is configured to perform disaster recovery on data in the source virtual disk; and
correspondingly, the migrating data in the cluster corresponding to the queried first target value to the second data center comprises: migrating data in the cluster corresponding to the queried first target value to the backup virtual disk.

3. The virtual disk migration method according to claim 2, wherein after the migrating data in the cluster corresponding to the queried first target value to the backup virtual disk, the method further comprises:
controlling, by the second data center, the virtual machine to operate on the basis of the backup virtual disk.

4. The virtual disk migration method according to claim 3, wherein before the controlling the virtual machine to operate on the basis of the backup virtual disk, the method further comprises:
migrating a memory resource of the virtual machine to the backup virtual disk.

5. The virtual disk migration method according to claim 2, wherein the migrating data in the cluster corresponding to the queried first target value to the second data center comprises:
migrating data in the cluster corresponding to the queried first target value to the disaster recovery virtual disk.

6. The virtual disk migration method according to claim 2, wherein an initialization step of the binary table comprises:
calculating a difference value between the backup virtual disk and the source virtual disk; and
determining the difference value as an initial label of each cluster of the source virtual disk in the binary table.

7. The virtual disk migration method according to claim 1, wherein the copying data in the cluster to a second data center comprises:
if a data copy time point is reached, performing the step of copying data in the cluster to a second data center.

8. (canceled)

9. A virtual disk migration device, comprising:
a memory, configured to store a computer program; and
a processor, configured to execute the computer program to implement the virtual disk migration method according to claim 1.

10. A readable storage medium, storing a computer program, the computer program being executed by a processor to implement the virtual disk migration method according to claim 1.

11. The virtual disk migration method according to claim 3, wherein an initialization step of the binary table comprises:
calculating a difference value between the backup virtual disk and the source virtual disk; and
determining the difference value as an initial label of each cluster of the source virtual disk in the binary table.

12. The virtual disk migration method according to claim 4, wherein an initialization step of the binary table comprises:
calculating a difference value between the backup virtual disk and the source virtual disk; and
determining the difference value as an initial label of each cluster of the source virtual disk in the binary table.

13. The virtual disk migration method according to claim 5, wherein an initialization step of the binary table comprises:
calculating a difference value between the backup virtual disk and the source virtual disk; and
determining the difference value as an initial label of each cluster of the source virtual disk in the binary table.
